(19) United States
(12) Patent Application Publication
(10) Pub. No.: US 2014/0012029 A1
(43) Pub. Date: Jan. 9, 2014

(54) METHOD FOR PRODUCING CYCLOHEXASILANE

(71) Applicant: Nippon Shokubai Co., Ltd., Osaka (JP)

(72) Inventors: Takashi ABE, Osaka (JP); Shin-ya IMOTO, Hyogo (JP); Morihiro KITAMURA, Osaka (JP); Hikaru TAKAHASHI, Osaka (JP)

(21) Appl. No.: 13/934,563

(22) Filed: Jul. 3, 2013

(30) Foreign Application Priority Data
Jul. 4, 2012 (JP) 2012-150907
Sep. 21, 2012 (JP) 2012-208800

(51) Int. Cl. C01B 33/04; C07F 7/21

(52) U.S. Cl. CPC C01B 33/04; C07F 7/21
USPC 556/430; 423/347

(57) ABSTRACT

Provided is a method for efficiently obtaining cyclohexasilane using a cyclic silane dianion salt as a raw material without a by-product such as silane gas by a simple device. The method for producing cyclohexasilane has a feature that a cyclic silane dianion salt represented by the following general formula (i) or general formula (ii) is reacted with an aluminum-based reducing agent or a boron-based reducing agent:

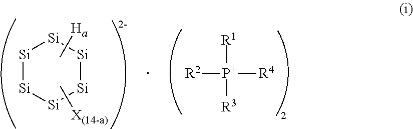

wherein X represents a halogen element, a represents an integer of 0 to 6, and R¹ to R⁴ each independently represent a hydrogen atom, an alkyl group, or an aryl group;

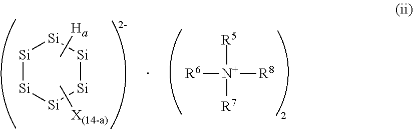

wherein X represents a halogen element, a represents an integer of 0 to 6, and R⁵ to R⁸ each independently represent a hydrogen atom, an alkyl group, or an aryl group.

### BACKGROUND OF THE INVENTION

(1) Field of the Invention

The present invention relates to a method for efficiently obtaining cyclohexasilane using a cyclic silane dianion salt as a raw material without forming a by-product such as silane gas or organic monosilane by a simple device, and further to a method for easily obtaining high-purity cyclohexasilane.

(2) Description of Related Art

A silicon thin film is used for applications such as solar cells and semiconductors, and this silicon thin film has been previously prepared by a vapor deposition film-forming method (CVD method) using monosilane as a raw material. Recently, in place of the CVD method, a new production method using cyclic silane hydride has been focused. This production method is a coating film-forming method (liquid process) in which a polysilane hydride solution is applied to a substrate, followed by calcination, and cyclopentasilane is used as a raw material for the preparation of the polysilane hydride solution. Cyclopentasilane is commercially available, and has been reported to be polysilane hydride by UV irradiation (T. Shimoda et. al., “Solution-processed silicon films and transistors”, Nature, 2006, vol. 440, p. 783). However, cyclopentasilane requires multistep synthesis using an expensive water-reactive reagent and a purification step for its production, and thus is very expensive.

Therefore, the present inventors have focused on cyclohexasilane as an alternate material for cyclopentasilane. It is known that cyclohexasilane can be produced by a method of preparing a salt of tetradecachlorocyclohexasilane dianion from trichlorosilane and a tertiary polyamine such as N,N,N′,N″,N″-pentaethyldiethylenetriamine (pedeta) or N,N,N′,N′-tetraethylethylenediamine (teeda), and bringing the salt of tetradecachlorocyclohexasilane dianion into contact with a metal hydride reducing agent to be reduced in diethyl ether (Japanese Patent No. 4519955 and WO 2011/094191).

However, according to the synthesis methods described in Japanese Patent No. 4519955 and WO 2011/094191, silane gas is necessarily produced as a by-product during reduction reaction. When silane gas is produced during the reaction, facility measures for eliminating the generated silane gas is necessary, and it causes problems that the device becomes complex and grows in size, and the process becomes complicated. Silane gas is considered to be derived from 1) a silicon component contained in a cationic moiety of the tetradecachlorocyclohexasilane dianion salt, or derived from 2) a component (impurities) having polyamine coordinated on a silicon atom, which is necessarily produced as a by-product when a tertiary polyamine is used as an additive.

In addition, even when organic cyclohexasilane is obtained by alkylation or arylation with bringing a Grignard reagent or an organic lithium reagent into contact with the salt of tetradecachlorocyclohexasilane dianion obtained through the methods described in Japanese Patent No. 4519955 and WO 2011/094191, organic monosilane is produced. When this organic monosilane is gaseous, the same problems as above are caused, and even if the organic monosilane is not gaseous, the purification step becomes complex, and it also causes a problem that the process becomes complicated.

Furthermore, as described above, when a salt of tetradecachlorocyclohexasilane dianion is synthesized using a tertiary polyamine, other than the intended salt of tetradecachlorocyclohexasilane dianion, impurities having polyamine coordinated on a silicon atom are produced as a by-product. When the salt of tetradecachlorocyclohexasilane dianion is reduced as in the state of containing the impurities, polyamine freed by reducing the impurities reacts with cyclohexasilane that is an objective substance, and consequently, the yield of cyclohexasilane may be lowered.

Furthermore, in the methods described in Japanese Patent No. 4519955 and WO 2011/094191, when the salt of tetradecachlorocyclohexasilane dianion is reduced to prepare cyclohexasilane, a salt is produced as a by-product. This by-product salt is usually removed by filtering the reaction solution. However, since the salt is dissolved in the solvent, it is at present difficult to obtain highly pure cyclohexasilane, only by this removal method.

### SUMMARY OF THE INVENTION

The present invention has been made by focusing on the situation as described above, and an object of the present invention is to provide a method for efficiently obtaining cyclohexasilane using a cyclic silane dianion salt as a raw material without forming a by-product such as silane gas or organic monosilane by a simple device, and further a method for easily obtaining high purity cyclohexasilane.

As a result of the extensive studies to solve the above problems, the present inventors have found that, a cyclic silane dianion salt having a specific structure with a phosphonium cation or an ammonium cation as a counter cation is used as a raw material that is subjected to reduction when synthesizing cyclohexasilane or subjected to alkylation or arylation when synthesizing organic cyclohexasilane, whereby the salt can be converted to cyclohexasilane without generating silane gas when reduced, and when subjected to alkylation or arylation, the salt can be converted to organic cyclohexasilane without producing organic monosilane, and thus cyclohexasilane is obtained in high yield.

Also, the present inventors have found that, when a specific ether-based solvent is used as a reaction solvent at the time of reducing the cyclic silane dianion salt, impurities (residual salts) are not dissolved and can be precipitated as a solid while dissolving an objective substance (cyclohexasilane) in the reaction solution after the reaction, then it is possible to efficiently isolate the impurities from the objective substance by solid-liquid separation such as filtration, and highly pure cyclohexasilane can be easily obtained with good productivity.

The present invention has been accomplished based on the above findings.

That is, a first method for producing cyclohexasilane of the present invention comprises reacting a cyclic silane dianion salt represented by the following general formula (i) or general formula (ii) with an aluminum-based reducing agent or a boron-based reducing agent.

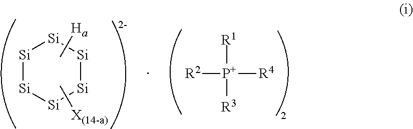

wherein X represents a halogen element, a represents an integer of 0 to 6, and R¹ to R⁴ each independently represent a hydrogen atom, an alkyl group, or an aryl group;

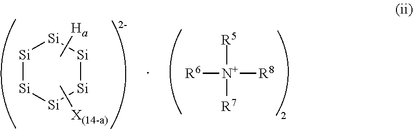

wherein X represents a halogen element, a represents an integer of 0 to 6, and R⁵ to R⁸ each independently represent a hydrogen atom, an alkyl group, or an aryl group.

A second method for producing cyclohexasilane of the present invention is a method for producing cyclohexasilane, comprising reducing a cyclic silane dianion salt with a reducing agent, wherein a solvent represented by the following general formula (iii)

R⁹—O—R¹⁰ (iii)

wherein R⁹ and R¹⁰ each independently represent an alkyl group, and the total carbon number of R⁹ and R¹⁰ is not less than 5, is used when the reduction is carried out.

In the second method for producing cyclohexasilane of the present invention, the solvent represented by the formula (iii) is preferably at least one solvent selected from the group consisting of cyclopentyl methyl ether, diisopropyl ether and methyl tertiary butyl ether. In addition, in the second method for producing cyclohexasilane of the present invention, the obtained reaction solution is preferably separated into solid and liquid after the reduction.

In the first and second methods for producing cyclohexasilane of the present invention, the reduction is preferably carried out by bringing the cyclic silane dianion salt into contact with the reducing agent in the presence of a solvent, and at least one of the cyclic silane dianion salt and the reducing agent is preferably added dropwise to a reaction system in which the reduction is carried out.

The method for producing organic cyclohexasilane of the present invention comprises reacting a cyclic silane dianion salt represented by the following general formula (i) or general formula (ii) with a Grignard reagent or an organic lithium reagent;

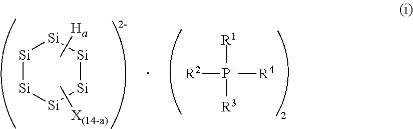

wherein X represents a halogen element, a represents an integer of 0 to 6, and R¹ to R⁴ each independently represent a hydrogen atom, an alkyl group, or an aryl group;

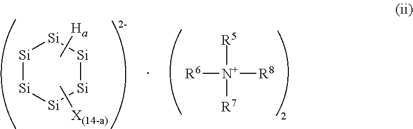

wherein X represents a halogen element, a represents an integer of 0 to 6, and R⁵ to R⁸ each independently represent a hydrogen atom, an alkyl group, or an aryl group.

Also, the present invention encompasses an organic cyclohexasilane represented by the following general formula (iv):

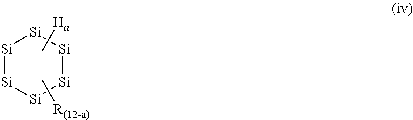

wherein R represents an alkyl group or an aryl group, and a represents an integer of 0 to 6.

The term “organic cyclohexasilane” as used herein refers to cyclohexasilane to which an organic group (a hydrocarbon group such as an alkyl group or an aryl group) is bound.

According to the first method for producing cyclohexasilane of the present invention and the method for producing organic cyclohexasilane of the present invention, since a cyclic silane dianion salt having a specific structure is used as a raw material, no silane gas is produced as a by product when subjected to reduction, and organic monosilane is not produced even when subjected to alkylation or arylation. Therefore, measures against silane gas and measures against organic monosilane previously performed in the production of cyclohexasilane and organic cyclohexasilane are unnecessary, and cyclohexasilane and organic cyclohexasilane can be efficiently produced by a simple device. Also, according to these production methods, it is possible to provide organic cyclohexasilane in which a hydrogen atom and an alkyl group or an aryl group are coexistent as a substituent of a Si atom, by selecting the structure of cyclic silane dianion salt.

In addition, according to the second method for producing cyclohexasilane of the present invention, a specific ether-based solvent is used for the reduction reaction, whereby residual salts to be impurities are not dissolved and can be precipitated as a solid while dissolving cyclohexasilane in the reaction solution after the reaction. As a result, cyclohexasilane is efficiently isolated by solid-liquid separation such as filtration, and highly pure cyclohexasilane can be easily obtained with good productivity.

### DETAILED DESCRIPTION OF THE PREFERRED EMBODIMENTS

### 1. First Method for Producing Cyclohexasilane and Method for Producing Organic Cyclohexasilane

### 1.1. Production Method

In both the method for producing cyclohexasilane of the present invention and the method for producing organic cyclohexasilane of the present invention, a cyclic silane dianion salt represented by the following general formula (i) or general formula (ii) is used as a raw material. The cyclic silane dianion salt having a specific structure has a phosphonium cation or an ammonium cation as a counter cation, thus when the salt is reduced, cyclohexasilane can be efficiently obtained in high yield without producing silane gas as a by-product. Also, when this cyclic silane dianion salt having a specific structure is subjected to alkylation or arylation, organic cyclohexasilane such as dodecamethylcyclohexasilane can be obtained without producing organic monosilane as a by-product.

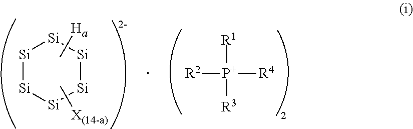

wherein X represents a halogen element, a represents an integer of 0 to 6, and R¹ to R⁴ each independently represent a hydrogen atom, an alkyl group, or an aryl group.

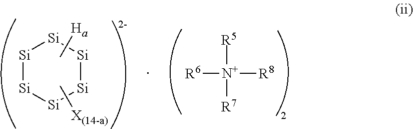

wherein X represents a halogen element, a represents an integer of 0 to 6, and R⁵ to R⁸ each independently represent a hydrogen atom, an alkyl group, or an aryl group.

In the general formula (i) and the general formula (ii), X may be a halogen atom, and X is preferably Cl, Br or I, more preferably Cl or Br, and further preferably Cl. With a cyclic silane dianion salt wherein X is Cl, it is possible to inexpensively produce cyclohexasilane or organic cyclohexasilane.

In the general formula (i) and the general formula (ii), a represents an integer of 0 to 6, and a is preferably not less than 1, preferably not more than 5, more preferably not more than 4, and further preferably not more than 3. For example, when a cyclic silane dianion salt wherein a is not less than 1 is used for the method for producing organic cyclohexasilane of the present invention, organic cyclohexasilane in which a hydrogen atom and an alkyl group or an aryl group are coexistent as a substituent of a Si atom.

In the general formula (i), examples of the alkyl group as examples of R¹ to R⁴ preferably include alkyl groups having a carbon number of 1 to 16 such as a methyl group, an ethyl group, a propyl group, a butyl group, a pentyl group, a hexyl group, a heptyl group, an octyl group and a cyclohexyl group, and examples of the aryl group as examples of R¹ to R⁴ preferably include aryl groups having a carbon number of 6 to 18 or so such as a phenyl group and a naphthyl group. Among them, a butyl group (Bu) and a phenyl group (Ph) are particularly preferable. In addition, R¹ to R⁴ may be each different, but all are preferably the same group.

In the general formula (ii), examples of the alkyl group as examples of R⁵ to R⁸ preferably include alkyl groups having a carbon number of 1 to 16 such as a methyl group, an ethyl group, a propyl group, a butyl group, a pentyl group, a hexyl group, a heptyl group, an octyl group and a cyclohexyl group, and examples of the aryl group as examples of R⁵ to R⁸ preferably include aryl groups having a carbon number of about 6 to 18 such as a phenyl group and a naphthyl group. Among them, a butyl group (Bu) and a phenyl group (Ph) are particularly preferable. In addition, R⁵ to R⁸ may be each different, but all are preferably the same group.

The cyclic silane dianion salt used in the first method for producing cyclohexasilane of the present invention and the method for producing organic cyclohexasilane of the present invention may be only one represented by the general formula (i) or general formula (ii) or may be a mixture of two or more thereof. For example, a mixture containing two or more cyclic silane dianion salts that are different only in a in the general formula (i) (or general formula (ii)) can be used.

A method for preparing the cyclic silane dianion salts represented by the general formula (i) and the general formula (ii) is not particularly limited, and for example, the cyclic silane dianion salts may be synthesized by applying a known organic synthesis technique to Japanese Patent No. 4519955 and WO 2011/094191 described above while reviewing the documents.

Examples of the phosphonium salt include quaternary phosphonium halides such as tetrabutylphosphonium chloride and tetraphenylphosphonium chloride. Examples of the ammonium salt include quaternary ammonium halides such as tetrabutylammonium chloride and tetraphenylammonium chloride.

In the first method for producing cyclohexasilane of the present invention, the cyclic silane dianion salt is reacted with an aluminum-based reducing agent or a boron-based reducing agent (hereinafter, may be collectively referred to as a “reducing agent”).

Examples of the aluminum-based reducing agent include metal hydrides such as lithium aluminum hydride, diisobutyl aluminum hydride and bis(2-methoxyethoxy) aluminum sodium hydride. These aluminum-based reducing agents may be used alone or in combination of two or more thereof.

Examples of the boron-based reducing agent include metal hydrides such as sodium borohydride and lithium triethylborohydride. These boron-based reducing agents may be used alone or in combination of two or more thereof.

In the method for producing organic cyclohexasilane of the present invention, the cyclic silane dianion salt is reacted with a Grignard reagent or an organic lithium reagent (hereinafter, may be collectively referred to as the “alkylating agent or arylating agent”).

Examples of the Grignard reagent include alkyl magnesium halides such as methyl magnesium bromide, and aryl magnesium halides such as phenyl magnesium bromide. These Grignard reagents may be used alone or in combination of two or more thereof.

Examples of the organic lithium reagent include alkyl lithium compounds such as methyl lithium, n-butyl lithium, sec-butyl lithium and tert-butyl lithium, and aryl lithium compounds such as phenyl lithium. These organic lithium reagents may be used alone or in combination of two or more thereof.

Hereinafter, the first method for producing cyclohexasilane of the present invention will be mainly described; however, in the method for producing organic cyclohexasilane of the present invention, it may be properly applied by replacing the term “reducing agent” with the term “alkylating agent or arylating agent”, “reduction reaction” with “alkylation reaction or arylation reaction”, and “cyclohexasilane” with “organic cyclohexasilane”, respectively.

The amount of the reducing agent to be used may be properly set, and for example, the number of hydrides of the reducing agent based on one silicon-halogen bond of the cyclic silane dianion salt may be at least not less than one time, and is preferably not less than twice and not more than fifty times, more preferably not less than five times and not more than forty times, and further preferably not less than ten times and not more than thirty times. When the amount of the reducing agent to be used is too large, post treatment takes time, and productivity tends to be lowered, and on the other hand, when the amount is too small, the yield tends to be lowered.

The reduction reaction can be carried out in the presence of an organic solvent as necessary. Examples of the organic solvent that can be used in the first method for producing cyclohexasilane of the present invention include, but are not particularly limited to, hydrocarbon-based solvents such as hexane and toluene; and ether-based solvents such as diethyl ether, tetrahydrofuran, cyclopentyl methyl ether, diisopropyl ether, and methyl tertiary butyl ether. Among them, a specific solvent set forth below to be used in the reduction reaction in the second method for producing cyclohexasilane of the present invention is preferable to obtain highly pure cyclohexasilane. These organic solvents may be used alone or in combination of two or more thereof. Here, the organic solvent to be used in the reduction reaction is preferably subjected to purification such as distillation or dehydration before the reaction for removing water and dissolved oxygen contained therein.

In the amount of the organic solvent to be used in the reduction reaction, the solid content concentration of the cyclic silane dianion salt, that is a reaction substrate, is preferably adjusted to not more than 1 mol/L, more preferably not more than 0.7 mol/L, further preferably not more than 0.5 mol/L, furthermore preferably not more than 0.4 mol/L, and particularly preferably not more than 0.3 mol/L. When the concentration of the cyclic silane dianion salt is higher than the above range, namely, when the amount of the organic solvent to be used is too small, the heat generated by the reaction is not sufficiently removed, and the problems such that the reactant is hard to be dissolved, thus the reaction rate is lowered, and the like may be caused. On the other hand, in the upper limit of the amount of the organic solvent to be used in the reduction reaction, the solid content concentration of the cyclic silane dianion salt is preferably adjusted to not less than 0.01 mol/L, more preferably not less than 0.02 mol/L, and further preferably not less than 0.03 mol/L. When the concentration of the cyclic silane dianion salt is lower than the above range, namely, when the amount of the organic solvent to be used is too large, the amount of the solvent that should be removed by distillation when the organic solvent and the objective product are separated after the reaction is increased, thus the productivity tends to be lowered.

The reduction reaction can be carried out by bringing the cyclic silane dianion salt into contact with the reducing agent. When the cyclic silane dianion salt is brought into contact with the reducing agent, the contact is preferably carried out in the presence of a solvent. In order to bring the cyclic silane dianion salt into contact with the reducing agent in the presence of a solvent, for example, mixing procedures such as 1) one of the cyclic silane dianion salt and the reducing agent is dissolved or dispersed in the solvent to be a solution or a dispersion, and the solution or dispersion is mixed with the other (the other is added to the solution or dispersion, or the solution or dispersion is added to the other), 2) both are dissolved or dispersed in each solvent to be a solution or a dispersion, and then both are mixed with each other, 3) the cyclic silane dianion salt and the reducing agent are simultaneously or sequentially added to the solvent, and the like may be adopted. Among them, the embodiment 2) is particularly preferable.

Also, when the cyclic silane dianion salt is brought into contact with the reducing agent, it is preferred that at least one (i.e., one or both) of the cyclic silane dianion salt and the reducing agent be added dropwise to the reaction system in which the reduction is carried out. One or both of the cyclic silane dianion salt and the reducing agent are added dropwise as described above, whereby exothermic generated in the reduction reaction can be controlled by the dropwise addition rate or the like, thus an effect of leading to improved productivity can be obtained such that it is possible to downsize a condenser or the like. When one is added dropwise, the other may be charged in the reaction system (reactor) together with the solvent or by itself (no solvent). When both are added dropwise, the solvent alone may be charged in the reaction system (reactor) beforehand, or the cyclic silane dianion salt and the reducing agent may be simultaneously or sequentially added dropwise to the empty reactor. In both cases, it is preferred that the one to be added dropwise (the cyclic silane dianion salt and/or the reducing agent) be dissolved or dispersed in the solvent to be a solution or a dispersion, and then added dropwise. When the specific solvent set forth below to be used in the reduction reaction in the second method for producing cyclohexasilane of the present invention is used as the organic solvent, it is preferred to use the specific solvent for a solution or dispersion containing the cyclic silane dianion salt as a solute, and for a solution or dispersion containing the reducing agent as a solute, the specific solvent may be used, or the other solvents described above may be used.

The preferred embodiment when one or both of the cyclic silane dianion salt and the reducing agent are added dropwise includes the following three embodiments. That is, A) an embodiment in which a solution or dispersion of the cyclic silane dianion salt is charged in the reactor, and a solution or dispersion of the reducing agent is added dropwise thereto, B) an embodiment in which a solution or dispersion of the reducing agent is charged in the reactor, and a solution or dispersion of the cyclic silane dianion salt is added dropwise thereto, and C) an embodiment in which a solution or dispersion of the cyclic silane dianion salt and a solution or dispersion of the reducing agent are simultaneously or sequentially added dropwise to the reactor. Among them, the embodiment A) is preferable.

When one or both of the cyclic silane dianion salt and the reducing agent are added dropwise by the embodiments A) to C), the solute concentration in the solution or dispersion containing the cyclic silane dianion salt as a solute is preferably not less than 0.01 mol/L, more preferably not less than 0.02 mol/L, further preferably not less than 0.04 mol/L, and particularly preferably not less than 0.05 mol/L. When the solute concentration is too low, the amount of the solvent that needs to be removed by distillation when isolating the objective product (cyclohexasilane or the like) is increased, and thus the productivity tends to be lowered. On the other hand, the upper limit of the solute concentration in the solution or dispersion containing the cyclic silane dianion salt as a solute is preferably not more than 1 mol/L, more preferably not more than 0.8 mol/L, further preferably not more than 0.7 mol/L, and particularly preferably not more than 0.5 mol/L. When the solute concentration (particularly, the solute concentration of the solution or dispersion to be added dropwise) is too high, exothermic in the reduction reaction tends to be hard for control.

When one or both of the cyclic silane dianion salt and the reducing agent are added dropwise by the embodiments A) to C), the dropwise addition rate depends on the solute concentration in the solution or dispersion, and is preferably not less than 0.01 mL/min and not more than 100 mL/min, more preferably not less than 0.1 mL/min and not more than 50 mL/min, and further preferably not less than 1 mL/min and not more than 20 mL/min.

When one or both of the cyclic silane dianion salt and the reducing agent are added dropwise by the embodiments A) to C), the dropwise addition time is not particularly limited, and is usually not less than 10 minutes, more preferably not less than 30 minutes, and further preferably not less than 1 hour, and usually not more than 24 hours, more preferably not more than 20 hours, further preferably not more than 18 hours, furthermore preferably not more than 12 hours, still further preferably not more than 10 hours, and still furthermore preferably not more than 6 hours.

The reaction temperature in the reduction reaction may be properly set depending on the types of the cyclic silane dianion salt and the reducing agent, and is usually −20° C. to 150° C., preferably not lower than −10° C., more preferably not lower than 0° C., preferably not higher than 100° C., more preferably not higher than 80° C., and further preferably not higher than 70° C. The reaction time may be properly determined depending on the extent of reaction progress, and is usually not less than 10 minutes and not more than 72 hours, preferably not less than 1 hour and not more than 48 hours, and more preferably not less than 2 hours and not more than 24 hours.

It is preferred that the reduction reaction be usually carried out under an atmosphere of an inert gas such as nitrogen gas or argon gas.

In the reduction reaction and the alkylation reaction or arylation reaction in the first method for producing cyclohexasilane of the present invention or the method for producing organic cyclohexasilane of the present invention as described above, silane gas and organic monosilane are not generated. Therefore, measures against silane gas and organic monosilane are not necessary in the above step, and cyclohexasilane or organic cyclohexasilane can be efficiently produced by a simple device.

The objective product (cyclohexasilane or organic cyclohexasilane) produced in the reduction reaction and the alkylation reaction or arylation reaction in the first method for producing cyclohexasilane of the present invention or the method for producing organic cyclohexasilane of the present invention can be isolated, for example, by separating a solid (impurities such by-product salts) from the reaction solution obtained in the reaction into solid and liquid, then removing the solvent by distillation under reduced pressure, or the like. As the method of the solid-liquid separation, filtration is preferably adopted for its simplicity, but the method is not limited thereto. For example, known solid-liquid separation methods such as centrifugation and decantation can be properly adopted.

### 1.2. Novel Organic Cyclohexasilane

The organic cyclohexasilane of the present invention will be described below. The organic cyclohexasilane of the present invention is represented by the following general formula (iv).

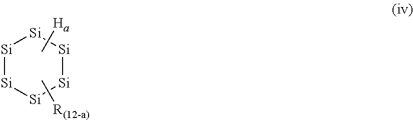

wherein R represents an alkyl group or an aryl group, and a represents an integer of 0 to 6.

In the general formula (iv), R is not particularly limited so long as it is an alkyl group or an aryl group, and the carbon number thereof is preferably from 1 to 8, and more preferably from 1 to 6. Specific examples of the substituent preferably include a methyl group, an ethyl group, a n-propyl group, an isopropyl group, a n-butyl group, a sec-butyl group, a tert-butyl group, and a phenyl group.

In the general formula (iv), a represents an integer of 0 to 6, and a is preferably not less than 1, preferably not more than 5, more preferably not more than 4, and further preferably not more than 3.

The organic cyclohexasilane of the present invention can be obtained by the method for producing organic cyclohexasilane of the present invention (i.e., the reaction of the cyclic silane dianion salt with a Grignard reagent or an organic lithium reagent). According to the method for producing organic cyclohexasilane of the present invention, a Grignard reagent or an organic lithium reagent that can introduce R in the general formula (iv) is selected as the Grignard reagent or organic lithium reagent to be used, and also a cyclic silane dianion salt in which the number of hydrogen atoms in a dianionic moiety (i.e., a in the general formula (i) or the general formula (ii)) is the same as a in the general formula (iv) as the cyclic silane dianion salt to be used, whereby a desired organic cyclohexasilane can be easily designed.

The organic cyclohexasilane of the present invention can be used as a raw material for silicon thin films, and is preferably utilized for applications such as solar cells and semiconductors.

### 2. Second Method for Producing Cyclohexasilane

In the second method for producing cyclohexasilane of the present invention, cyclohexasilane is produced by reducing a cyclic silane dianion salt with a reducing agent.

In this production method, the cyclic silane dianion salt is not particularly limited, and for example, in addition to the cyclic silane dianion salts represented by the general formula (i) or general formula (ii) described above, a cyclic silane dianion salt in which a cationic moiety of these cyclic silane dianion salts is a cation other than a phosphonium ion or an ammonium ion can be also used. Particularly, a tetradecachlorocyclohexasilane dianion salt is preferable to obtain further highly pure cyclohexasilane.

The tetradecachlorocyclohexasilane dianion salt includes tetradecachlorocyclohexasilane dianion ([Si₆Cl₁₄²⁻]) and a cation that is a counter ion of the anion, and is preferably represented by the following formula (v)

[Xⁿ⁺]_{2/n}[Si₆Cl₁₄²⁻] (v)

wherein Xⁿ⁺ is a cation, n represents the cation valence and is preferably 1.

Xⁿ⁺ is not particularly limited so long as it can form a stable salt with the dianion, and examples thereof include compounds in which a tertiary polyamine and a chlorosilane residue are bound; and oniums.

The tertiary polyamine includes polyalkylamines in which an alkylene group (an alkylene group having a carbon number of 1 to 6 such as an ethylene group is particularly preferable) and an alkyl group (an alkyl group having a carbon number of 1 to 6 such as an ethyl group is particularly preferable) are bound to a nitrogen atom, such as N,N,N′,N″,N″-pentaethyldiethylenetriamine (referred to as “pedeta”), and the repeating unit of alkyleneamine is, for example, not less than 2, preferably about 2 to 6, and further preferably about 2 to 4. In addition, the chlorosilane residue is a chlorosilane in which the tertiary polyamine, a chlorine atom and a hydrogen atom are coordinated to a silicon atom.

The oniums include phosphoniums (such as tetraalkylphosphonium and tetraarylphosphonium represented by R³₄P (R³ is an alkyl group having a carbon number of 1 to 6 or an aryl group having a carbon number of 6 to 20)), and ammoniums (such as tetraalkylammonium and tetraarylammonium represented by R³₄N (R³ is an alkyl group having a carbon number of 1 to 6 or an aryl group having a carbon number of 6 to 20)).

The tetradecachlorocyclohexasilane dianion salt can be prepared, for example, by coupling trichlorosilane, in the presence of a tertiary polyamine or an onium halide salt. As the tertiary polyamine, tertiary polyamines that are the same as those described above can be used, and as the onium halide salt, salts of the oniums and halogen anions (particularly chloro anion) can be used. Here, the coupling reaction of trichlorosilane is desirably carried out under substantially anhydrous conditions, and for example, is recommended to be carried out under a dry gas (particularly an inert gas) atmosphere. Also, this coupling reaction can be carried out in an organic solvent as necessary, and examples of the organic solvent include aprotic polar solvents (such as halogenated hydrocarbon-based solvents, ether-based solvents, ketone-based solvents, and ester-based solvents). Preferable examples of the organic solvent include chlorinated hydrocarbon-based solvents such as chloroform, dichloromethane and 1,2-dichloroethane, and the organic solvent is particularly preferably 1,2-dichloroethane. The coupling reaction temperature can be properly set depending on the reactivity, and for example, is about 0° C. to 120° C., and preferably about 15° C. to 70° C. The tetradecachlorocyclohexasilane dianion salt generated in the coupling reaction can be easily isolated from the reaction solution by filtration or the like.

Here, in the second method for producing cyclohexasilane of the present invention, when the cyclic silane dianion salt represented by the general formula (i) or general formula (ii) described above is used, highly pure cyclohexasilane can be obtained while avoiding generation of silane gas during reduction. Particularly when a tetradecachlorocyclohexasilane dianion salt in which a is 0 in the general formula (i) or general formula (ii) is used, more highly pure cyclohexasilane can be obtained while avoiding generation of silane gas during reduction.

The reducing agent that can be used in the second method for producing cyclohexasilane of the present invention is not particularly limited, and those described above as the reducing agent in the first method for producing cyclohexasilane of the present invention are preferably used. Here, the reducing agent may be used alone or in combination of two or more thereof. In addition, the amount of the reducing agent to be used in this case is also the same as the amount of the reducing agent in the first method for producing cyclohexasilane of the present invention.

In the second method for producing cyclohexasilane of the present invention, it is important to use a solvent represented by the following general formula (iii)

R⁹—O—R¹⁰ (iii)

wherein R⁹ and R¹⁰ each independently represent an alkyl group, and the total carbon number of R⁹ and R¹⁰ is not less than 5
(may be referred to as a “specific solvent”), when the reduction is carried out. When this specific solvent is used, while cyclohexasilane that is an objective substance is dissolved in the reaction solution, the residual salts to be impurities are not dissolved in the reaction solution and are precipitated as a solid. Accordingly, cyclohexasilane can be efficiently isolated by separating the reaction solution into solid and liquid by filtration or the like, and highly pure cyclohexasilane is obtained.

In the formula (iii), examples of the alkyl group represented by R⁹ and R¹⁰ include alkyl groups preferably having a carbon number of 1 to 20, more preferably having a carbon number of 1 to 10, and further preferably having a carbon number of 1 to 6, and specific examples thereof include a methyl group, an ethyl group, a propyl group, an isopropyl group, a butyl group, a tertiary butyl group, a pentyl group, a cyclopentyl group, a hexyl group, and a cyclohexyl group. Also, in the formula (iii), the total carbon number of R⁹ and R¹⁰ is not less than 5 and preferably not less than 6. The upper limit of the total carbon number of R⁹ and R¹⁰ is not particularly limited, and is usually not more than 15, preferably not more than 12, and more preferably not more than 10.

As the solvent (specific solvent) represented by the formula (iii), specifically at least one solvent selected from the group consisting of cyclopentyl methyl ether, diisopropyl ether and methyl tertiary butyl ether is preferable. The specific solvent may be used alone or in combination of two or more thereof.

In the reduction in the second method for producing cyclohexasilane of the present invention, other solvents usually used in the reduction reaction (for example, hydrocarbon-based solvents such as hexane and toluene) may be used, together with the specific solvent. When the other solvents are used, the ratio of the specific solvent is preferably not less than 30% by mass, more preferably not less than 40% by mass, and further preferably not less than 50% by mass, in the total amount of the solvents used during the reaction. For example, when a reducing agent that is hard to be dissolved with the specific solvent is used, the reducing agent is dissolved with a small amount of the other solvents and is subjected to reduction reaction, whereby the reactivity can be improved. Here, the total amount of the specific solvent and other solvents to be used in the reduction reaction is the same as the amount of the organic solvent to be used in the reduction reaction in the first method for producing cyclohexasilane of the present invention.

The specific solvent and the other solvents may be subjected to purification such as distillation or dehydration before the reaction for removing water and dissolved oxygen contained therein.

In the second method for producing cyclohexasilane of the present invention, the obtained reaction solution is preferably separated into solid and liquid after carrying out the reduction. As described above, in the reaction solution obtained in the reduction reaction in this production method, cyclohexasilane that is an objective substance is dissolved, and residual salts to be impurities are not dissolved and are precipitated as a solid. Accordingly, the reaction solution obtained after the reduction can be easily separated into solid and liquid. Furthermore, the solid precipitated at the time (residual salts) has a certain particle size, and for example, good filterability can be maintained without clogging in a filter having micropores of about 20 to 30 μm.

As the method of the solid-liquid separation, filtration is preferably adopted for its simplicity, but the method is not limited thereto. For example, known solid-liquid separation methods such as centrifugation and decantation can be properly adopted.

In the second method for producing cyclohexasilane of the present invention, after removing the solid (residual salts) from the reaction solution by the solid-liquid separation, the solvent is removed by filtration under reduced pressure or the like, whereby cyclohexasilane can be isolated.

As described above, according to the second method for producing cyclohexasilane of the present invention, cyclohexasilane can be easily obtained with good productivity. Moreover, cyclohexasilane obtained by this production method is surely separated from the residual salts to be impurities, and thus is of very high purity. For example, the purity of cyclohexasilane obtained by this production method is usually not less than 90%, preferably not less than 95%, more preferably not less than 98%, and further preferably not less than 99%. In the present invention, the purity of cyclohexasilane is determined by measuring ¹H-NMR and calculating from the integral ratio of the cyclohexasilane peak to the other peaks than cyclohexasilane. When the other peaks than cyclohexasilane are not observed, the purity can be determined as not less than 99%.

This application claims the benefits of priority based on Japanese Patent Application No. 2012-150907, filed on Jul. 4, 2012, and priority based on Japanese Patent Application No. 2012-208800, filed on Sep. 21, 2012. The entire content of the specification of Japanese Patent Application No. 2012-150907, filed on Jul. 4, 2012, and that of the specification of Japanese Patent Application No. 2012-208800, filed on Sep. 21, 2012, are incorporated into this application by reference.

### EXAMPLES

The present invention will be more specifically described below with reference to Examples, but the present invention is not limited to the following Examples, and can be implemented with appropriate modifications within the scope conforming to the purport of what is mentioned above and below herein. All of such modifications are included in the technical scope of the present invention.

Here, all reactions in Examples were carried out under an inert gas (nitrogen or argon) atmosphere. Also, solvents used in the reaction in Examples were used after water and oxygen were removed.

### Example 1-1

The inside of a 300-mL four-necked flask equipped with a thermometer, a condenser, a dropping funnel and a stirrer was replaced with nitrogen gas, and 6.6 g (20 mmol) of N,N,N′,N′-tetraethylethylenediamine, 10.0 g (26 mmol) of tetraphenylphosphonium chloride and 100 mL of dichloromethane were then charged therein, to prepare a solution. Subsequently, while stirring the solution in the flask, 10.8 g (78 mmol) of trichlorosilane was slowly added dropwise from the dropping funnel in the condition of 25° C. After the completion of dropwise addition, the reaction was carried out by stirring the mixture at room temperature for 24 hours, hexane (20 mL) was then added to the obtained reaction mixture, and the mixture was left at room temperature for 3 days, to separate a precipitated white solid (I) by filtration. When this white solid (I) was analyzed by IR, it was confirmed to be a tetradecachlorocyclohexasilane dianion salt ([Ph₄P⁺]₂[Si₆Cl₁₄²⁻]).

Next, 2.80 g of the white solid (I) obtained above was charged in a 100-mL three-necked flask equipped with a dropping funnel and a stirrer, and was dried under a reduced pressure. Then, the inside of the flask was replaced with argon gas, and 30 mL of cyclopentyl methyl ether was added as a solvent. Subsequently, while stirring the suspension in the flask, 10 mL of a solution of lithium aluminum hydride in diethyl ether (concentration: about 1.0 mol/L) was gradually added dropwise as a reducing agent from the dropping funnel in the condition of 25° C., and then the reaction was carried out by stirring the mixture at 25° C. for 5 hours. Silane gas was not generated during this reaction. After the reaction, the reaction solution was filtered under a nitrogen gas atmosphere, to remove the produced salt. The solvent was removed by filtration from the obtained filtrate under reduced pressure, to obtain a colorless transparent liquid of cyclohexasilane at a yield of not less than 90%.

### Example 1-2

In a 300-mL three-necked flask equipped with a thermometer, a dropping funnel and a stirrer was charged 12.9 g of the white solid (I) obtained in Example 1-1, and the white solid (I) was dried under reduced pressure. Then, the inside of the flask was replaced with nitrogen gas, and 100 mL of tetrahydrofuran was added as a solvent. Subsequently, while stirring the suspension in the flask, 130 mL of a solution of methyl magnesium bromide in tetrahydrofuran (concentration: about 1.0 mol/L) was gradually added dropwise from the dropping funnel under the condition of 25° C., and then the reaction was carried out by stirring the mixture at 25° C. for 24 hours. Organic monosilane was not generated during this reaction. The obtained reaction mixture was hydrolyzed, the product was then extracted with hexane and cyclopentyl methyl ether, and the extract was concentrated under a reduced pressure, followed by recrystallization under low temperature conditions (−30° C. to 0° C.), to obtain a colorless crystal of dodecamethylcyclohexasilane at a yield of not less than 90%.

### Example 2-1

Under a nitrogen gas atmosphere, 470 mg (12.3 mmol) of lithium aluminum hydride (manufactured by Aldrich) as a reducing agent and 25 mL of cyclopentyl methyl ether (CPME) as a solvent were charged in a two-necked flask, and the mixture was stirred at room temperature for 1 hour, to prepare a slurry solution of lithium aluminum hydride (manufactured by Aldrich). As the cyclopentyl methyl ether (CPME), a dehydrated product manufactured by Wako Pure Chemical Industries, Ltd. was passed through a solvent purification system (manufactured by Glass Contour), and used (the same applies “cyclopentyl methyl ether” described hereinafter). Separately, under an argon gas atmosphere, 3.1 g (2.44 mmol) of [pedeta SiH₂Cl+]₂[Si₆Cl₁₄²⁻] as a precursor compound and 15 mL of cyclopentyl methyl ether (CPME) as a solvent were charged in a separate 100-mL two-necked flask, and the mixture was stirred at room temperature. To this 100-mL two-necked flask was added dropwise the slurry solution of lithium aluminum hydride prepared beforehand from a dropping funnel over 20 minutes, and after the completion of the dropwise addition, the reaction was carried out by stirring the mixture at room temperature for 5 hours. During the reaction, argon gas was allowed to flow through the flask, to pass through two traps with an aqueous potassium hydroxide solution inside, thereby trapping and exhausting silane gas generated as a by-product in this reaction. After the completion of the reaction, the reaction solution was filtered using a glass filter with a micropore size of 20 to 30 μm under a nitrogen gas atmosphere, and the solvent was removed by filtration from the obtained filtrate, to obtain cyclohexasilane as a colorless transparent liquid.

When ¹H-NMR (400 MHz, C₆D₆; a measurement system manufactured by Varian Inc.) of the obtained cyclohexasilane was measured, a peak other than the peak derived from cyclohexasilane (3.35 ppm) was not observed, and the purity of the obtained cyclohexasilane was not less than 99%. When ²⁹Si-NMR (79 MHz, C₆D₆; a measurement system manufactured by Bruker Corporation) was also measured, a peak other than the peak derived from cyclohexasilane (−106.9 ppm) was not also observed in ²⁹Si-NMR.

### Example 2-2

Cyclohexasilane as a colorless transparent liquid was obtained in the same manner as in Example 2-1, except for using diisopropyl ether (manufactured by Wako Pure Chemical Industries, Ltd., dehydrated product) in place of CPME as a solvent.

When ¹H-NMR (400 MHz, C₆D₆; a measurement system manufactured by Varian Inc.) of the obtained cyclohexasilane was measured, a peak other than the peak derived from cyclohexasilane (3.35 ppm) was not observed, and the purity of the obtained cyclohexasilane was not less than 99%. When ²⁹Si-NMR (79 MHz, C₆D₆; a measurement system manufactured by Bruker Corporation) was also measured, a peak other than the peak derived from cyclohexasilane (−106.9 ppm) was not also observed in ²⁹Si-NMR.

### Example 2-3

Under a nitrogen gas atmosphere, 3.1 g (2.44 mmol) of [pedeta SiH₂Cl⁺]₂[Si₆Cl₁₄²⁻] as a precursor compound and 25 mL of CPME as a solvent were charged in a two-necked flask, and the mixture was stirred at room temperature for 1 hour, to prepare a slurry solution of the precursor compound. Separately, under an argon gas atmosphere, 470 mg (12.3 mmol) of lithium aluminum hydride (manufactured by Aldrich) as a reducing agent and 15 mL of CPME as a solvent were charged in a separate 100 mL two-necked flask, and the mixture was stirred at room temperature. To this 100-mL two-necked flask was added dropwise the slurry solution of the precursor compound prepared beforehand from a dropping funnel over 20 minutes, and after the completion of the dropwise addition, the reaction was carried out by stirring the mixture at room temperature for 5 hours. During the reaction, argon gas was allowed to flow through the flask, to pass through two traps with an aqueous potassium hydroxide solution inside, thereby trapping and exhausting silane gas generated as a by-product in this reaction. After the completion of the reaction, the reaction solution was filtered using a glass filter with a micropore size of 20 to 30 μm under a nitrogen gas atmosphere, and the solvent was removed by filtration from the obtained filtrate, to obtain cyclohexasilane as a colorless transparent liquid.

When ¹H-NMR (400 MHz, C₆D₆; a measurement system manufactured by Varian Inc.) of the obtained cyclohexasilane was measured, a peak other than the peak derived from cyclohexasilane (3.35 ppm) was not observed, and the purity of the obtained cyclohexasilane was not less than 99%. When ²⁹Si-NMR (79 MHz, C₆D₆; a measurement system manufactured by Bruker Corporation) was also measured, a peak other than the peak derived from cyclohexasilane (−106.9 ppm) was not also observed in ²⁹Si-NMR.

### Example 2-4

Under a nitrogen gas atmosphere, 470 mg (12.3 mmol) of lithium aluminum hydride (manufactured by Aldrich) as a reducing agent and 25 mL of CPME as a solvent were charged in a two-necked flask, and the mixture was stirred at room temperature for 1 hour, to prepare a slurry solution of lithium aluminum hydride. Separately, under an argon gas atmosphere, 2.8 g (2.44 mmol) of [Bu₄N+]2[Si₆Cl₁₄²⁻] as a precursor compound and 15 mL of CPME as a solvent were charged in a separate 100-mL two-necked flask, and the mixture was stirred at room temperature. To this 100-mL two-necked flask was added dropwise the slurry solution of lithium aluminum hydride prepared beforehand from a dropping funnel over 20 minutes, and after the completion of the dropwise addition, the reaction was carried out by stirring the mixture at room temperature for 5 hours. Silane gas was not generated during this reaction. After the completion of the reaction, the reaction solution was filtered using a glass filter with a micropore size of 20 to 30 μm under a nitrogen gas atmosphere, and the solvent was removed by filtration from the obtained filtrate, to obtain cyclohexasilane as a colorless transparent liquid.

When ¹H-NMR (400 MHz, C₆D₆; a measurement system manufactured by Varian Inc.) of the obtained cyclohexasilane was measured, a peak other than the peak derived from cyclohexasilane (3.35 ppm) was not observed, and the purity of the obtained cyclohexasilane was not less than 99%. When ²⁹Si-NMR (79 MHz, C₆D₆; a measurement system manufactured by Bruker Corporation) was also measured, a peak other than the peak derived from cyclohexasilane (−106.9 ppm) was not also observed in ²⁹Si-NMR.

### Comparative Example 1

Under an argon gas atmosphere, 3.1 g (2.44 mmol) of [pedeta SiH₂Cl⁺]₂[Si₆Cl₁₄²⁻] as a precursor compound and 15 mL of diethyl ether (manufactured by Wako Pure Chemical Industries, Ltd., dehydrated product) as a solvent were charged in a 100-mL two-necked flask, and the mixture was stirred at room temperature. To this 100-mL two-necked flask was added dropwise 12.3 mL of a solution obtained by dissolving 1 M lithium aluminum hydride (manufactured by Aldrich) as a reducing agent in diethyl ether (manufactured by Wako Pure Chemical Industries, Ltd., dehydrated product) from a dropping funnel over 20 minutes, and after the completion of the dropwise addition, the reaction was carried out by stirring the mixture at room temperature for 5 hours. During the reaction, argon gas was allowed to flow through the flask, and to pass through two traps with an aqueous potassium hydroxide solution inside, thereby trapping and exhausting silane gas generated as a by-product in this reaction. After the completion of the reaction, the reaction solution was filtered using a glass filter with a micropore size of 20 to 30 μm under a nitrogen gas atmosphere, and the solvent was removed by filtration from the obtained filtrate, to obtain cyclohexasilane containing a white precipitate.

### Comparative Example 2

Under an argon gas atmosphere, 3.1 g (2.44 mmol) of [pedeta SiH₂Cl⁺]₂[Si₆Cl₁₄²⁻] as a precursor compound and 15 mL of tetrahydrofuran (manufactured by Wako Pure Chemical Industries, Ltd., dehydrated product) as a solvent were charged in a 100-mL two-necked flask, and the mixture was stirred at room temperature. To this 100-mL two-necked flask was added dropwise 6.2 mL of a solution obtained by dissolving 2 M lithium aluminum hydride (manufactured by Aldrich) as a reducing agent in tetrahydrofuran (manufactured by Wako Pure Chemical Industries, Ltd., dehydrated product) from a dropping funnel over 20 minutes, and after the completion of the dropwise addition, the reaction was carried out by stirring the mixture at room temperature for 5 hours. During the reaction, argon gas was allowed to flow through the flask, and to pass through two traps with an aqueous potassium hydroxide solution inside, thereby trapping and exhausting silane gas generated as a by-product in this reaction. After the completion of the reaction, the reaction solution was filtered using a glass filter with a micropore size of 20 to 30 μm under a nitrogen gas atmosphere, and the solvent was removed by filtration from the obtained filtrate, then the intended cyclohexasilane was not obtained.

### Comparative Example 3

Under an argon gas atmosphere, 3.1 g (2.44 mmol) of [pedeta SiH₂Cl⁺]₂[Si₆Cl₁₄²⁻] as a precursor compound and 470 mg (12.3 mmol) of lithium aluminum hydride (manufactured by Aldrich) as a reducing agent were charged in a 100-mL two-necked flask, and the mixture was stirred at room temperature. To this 100-mL two-necked flask was added dropwise 25 mL of 1,2-dimethoxyethane (manufactured by Wako Pure Chemical Industries, Ltd., dehydrated product) as a solvent from a dropping funnel over 20 minutes, and after the completion of the dropwise addition, the reaction was carried out by stirring the mixture at room temperature for 5 hours. During the reaction, argon gas was allowed to flow through the flask, and to pass through two traps with an aqueous potassium hydroxide solution inside, thereby trapping and exhausting silane gas generated as a by-product in this reaction. After the completion of the reaction, the reaction solution was filtered using a glass filter with a micropore size of 20 to 30 μm under a nitrogen gas atmosphere, and the solvent was removed by filtration from the obtained filtrate, then the intended cyclohexasilane was not obtained.

1. A method for producing a cyclohexasilane, comprising reacting a cyclic silane dianion salt represented by the following general formula (i) or general formula (ii) with an aluminum-based reducing agent or a boron-based reducing agent: 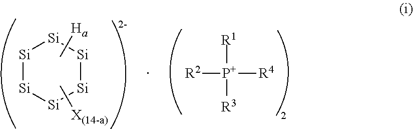
wherein X represents a halogen element, a represents an integer of 0 to 6, and R¹ to R⁴ each independently represent a hydrogen atom, an alkyl group, or an aryl group; 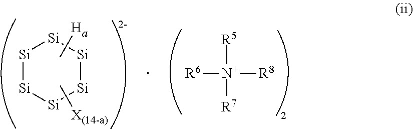
wherein X represents a halogen element, a represents an integer of 0 to 6, and R⁵ to R⁸ each independently represent a hydrogen atom, an alkyl group, or an aryl group.

2. A method for producing cyclohexasilane, comprising reducing a cyclic silane dianion salt with a reducing agent, wherein a solvent represented by the following general formula (iii)
R⁹—O—R¹⁰ (iii)
wherein R⁹ and R¹⁰ each independently represent an alkyl group, and the total carbon number of R⁹ and R¹⁰ is not less than 5,
is used when the reduction is carried out.

3. The method for producing cyclohexasilane according to claim 2, wherein the solvent represented by the formula (iii) is at least one solvent selected from the group consisting of cyclopentyl methyl ether, diisopropyl ether and methyl tertiary butyl ether.

4. The method for producing cyclohexasilane according to claim 2, wherein the obtained reaction solution is separated into solid and liquid after the reduction.

5. The method for producing cyclohexasilane according to claim 1, wherein the reduction is carried out by bringing the cyclic silane dianion salt into contact with the reducing agent in the presence of a solvent.

6. The method for producing cyclohexasilane according to claim 1, wherein at least one of the cyclic silane dianion salt and the reducing agent is added dropwise to a reaction system in which the reduction is carried out.

7. A method for producing organic cyclohexasilane, wherein a cyclic silane dianion salt represented by the following general formula (i) or general formula (ii) is reacted with a Grignard reagent or an organic lithium reagent: 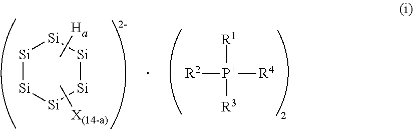
wherein X represents a halogen element, a represents an integer of 0 to 6, and R¹ to R⁴ each independently represent a hydrogen atom, an alkyl group, or an aryl group; 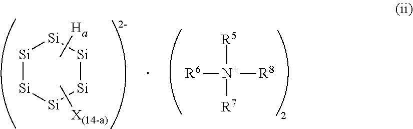
wherein X represents a halogen element, a represents an integer of 0 to 6, and R⁵ to R⁸ each independently represent a hydrogen atom, an alkyl group, or an aryl group.

8. An organic cyclohexasilane represented by the following general formula (iv): 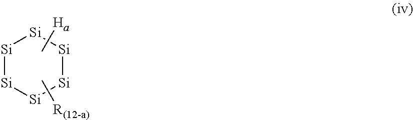
wherein R represents an alkyl group or an aryl group, and a represents an integer of 0 to 6.

9. The method for producing cyclohexasilane according to claim 3, wherein the obtained reaction solution is separated into solid and liquid after the reduction.

10. The method for producing cyclohexasilane according to claim 2, wherein the reduction is carried out by bringing the cyclic silane dianion salt into contact with the reducing agent in the presence of a solvent.

11. The method for producing cyclohexasilane according to claim 2, wherein at least one of the cyclic silane dianion salt and the reducing agent is added dropwise to a reaction system in which the reduction is carried out.
